(19) United States
(12) Patent Application Publication
(10) Pub. No.: US 2014/0131345 A1
(43) Pub. Date: May 15, 2014

(54) INDUCTIVELY HEATED DIVIDER FOR AN OVEN APPLIANCE

(71) Applicant: GENERAL ELECTRIC COMPANY, Schenectady, NY (US)

(72) Inventors: Eric K. Watson, Crestwood, KY (US); Paul Bryan Cadima, Prospect, KY (US)

(73) Assignee: GENERAL ELECTRIC COMPANY, Schenectady, NY (US)

(21) Appl. No.: 13/674,385

(22) Filed: Nov. 12, 2012

(51) Int. Cl. H05B 6/12

(52) U.S. Cl. CPC H05B 6/129
USPC 219/620

(57) ABSTRACT

An oven appliance having a divider whereby the cooking chamber can be separated into multiple portions for cooking operations is provided. The divider includes a shelf onto which food items can be placed for cooking The divider is inductively heated so that food items can be heated from both the bottom and top regardless of into which portion of the cooking chamber the food item is placed

### FIELD OF THE INVENTION

The subject matter of the present disclosure relates generally to an oven appliance having an inductively heated divider that separates the oven chamber into multiple cavities.

### BACKGROUND OF THE INVENTION

An oven appliance typically includes an oven cavity or cooking chamber where food items can be placed for cooking One or more heating sources are provided to provide heat energy into the cooking chamber. The food may receive radiant energy as well as heat energy through conduction and/or convection inside the cooking chamber.

Oven appliances may be provided in a dual format where two separate cooking chambers are provided each with their own controls and heating elements. Alternatively, the appliance may include a single cooking chamber. Adjustable racks are typically provided to allow for height adjustment and/or the cooking of multiple food items.

As a matter of e.g., consumer convenience, it may be desirable to divide the cooking chamber into multiple portions. For example, dividing the cooking chamber into a top portion and a bottom portion can be useful for cooking different food items at different temperatures. A heating element in the top portion could be operated to provide a relatively higher cooking temperature while a heating element in the bottom portion could be operated to provide a relatively lower cooking temperature depending upon e.g., the food items. The oven appliance can be configured to allow for separate control of different heating elements when the cooking chamber is divided into multiple portions.

However, dividing the cooking chamber can also have certain disadvantages. Using the example above, the top portion of the cooking chamber will be heated by a heating element typically located in a top wall of the appliance while the bottom portion will be heated by another heating element typically located in the bottom of the appliance. Depending upon the e.g., the food item being cooked and the time used for cooking operations, the food item may not be cooked and/or browned as evenly or as uniformly as compared to normal operation with heating elements positioned both above and below the food item.

Accordingly, an oven appliance having a cooking chamber that can be divided into multiple portions would be useful. More particularly, an oven appliance where the cooking chamber can be divided into multiple portions where each portion can be provided with heat at locations both above and below the food item would be particularly useful. Such an appliance where the size of the divided portions is adjustable would also be beneficial.

### BRIEF DESCRIPTION OF THE INVENTION

The present invention provides an oven appliance having a divider whereby the cooking chamber can be separated into multiple portions for cooking operations. The divider includes a shelf onto which food items can be placed for cooking The divider is inductively heated so that food items can be heated from both the bottom and top regardless of into which portion of the cooking chamber the food item is placed. Additional aspects and advantages of the invention will be set forth in part in the following description, or may be apparent from the description, or may be learned through practice of the invention.

In one exemplary embodiment, the present invention provides an oven appliance that includes an oven chamber defined by a top wall, a bottom wall, and at least one exterior wall extending between the top wall and the bottom wall. The oven chamber defines an opening through which food items may be placed into the oven chamber for cooking operations. A ferrous divider is provided that includes a shelf for the receipt of food items. The divider is removably attached to the exterior wall and separates the oven chamber into multiple cavities. A magnetic flux generating coil is positioned proximate to the divider so as to create eddy currents in the divider and generate heat when the coil is energized.

In another exemplary embodiment, the present invention provides an oven appliance that includes a cooking chamber comprising a pair of opposing side walls, a rear wall, a top wall, and a bottom wall. The cooking chamber defines an opening for the receipt of food items for cooking A heating source provides heat to the cooking chamber for cooking operations. A divider is positioned in the cooking chamber and includes a shelf for supporting food items. The divider is positioned in the cooking chamber so as to divide the cooking chamber into at least two portions. The divider comprises a ferrous material. A magnetic flux generating coil is located near the divider and is configured to generate eddy currents in the divider so as to provide heat for cooking operations.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of an exemplary embodiment of an oven appliance of the present invention.

FIG. 2 provides perspective, cross-sectional view of an exemplary oven chamber of the present invention.

FIG. 3 provide a side cross-sectional view of the exemplary embodiment of an oven chamber shown in FIG. 2.

FIGS. 4 and 5 provide cross-sectional views of additional exemplary embodiments of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

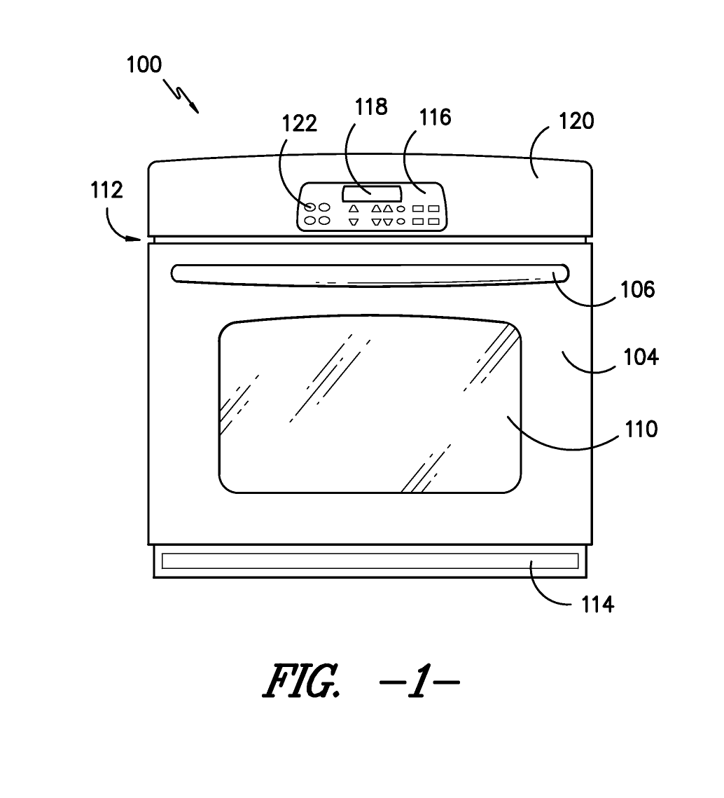

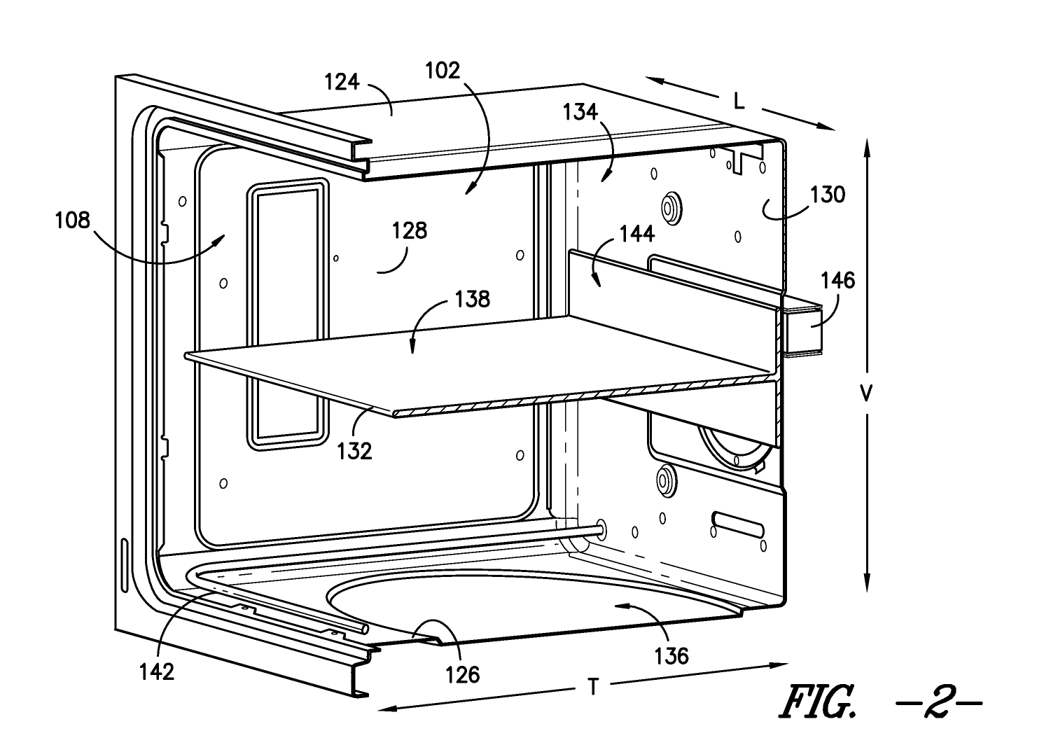

Referring to FIGS. 1 and 2, an oven 100 with oven chamber 102 according to an exemplary embodiment of the present invention is shown. FIG. 1 provides a front view of oven 100 while FIG. 2 provides a side, cross-sectional view of the oven cavity or cooking chamber 102. Oven 100 includes a door 104 with handle 106 that provides for opening and closing access to oven cavity 102 through front opening 108. A window 110 on door 104 allows the user to view e.g., food items during the cooking process. Vents at 112 and 114 are connected with ventilation passage ways located in e.g., spaces between the oven cabinet (not shown) and the walls of the cooking chamber (identified below).

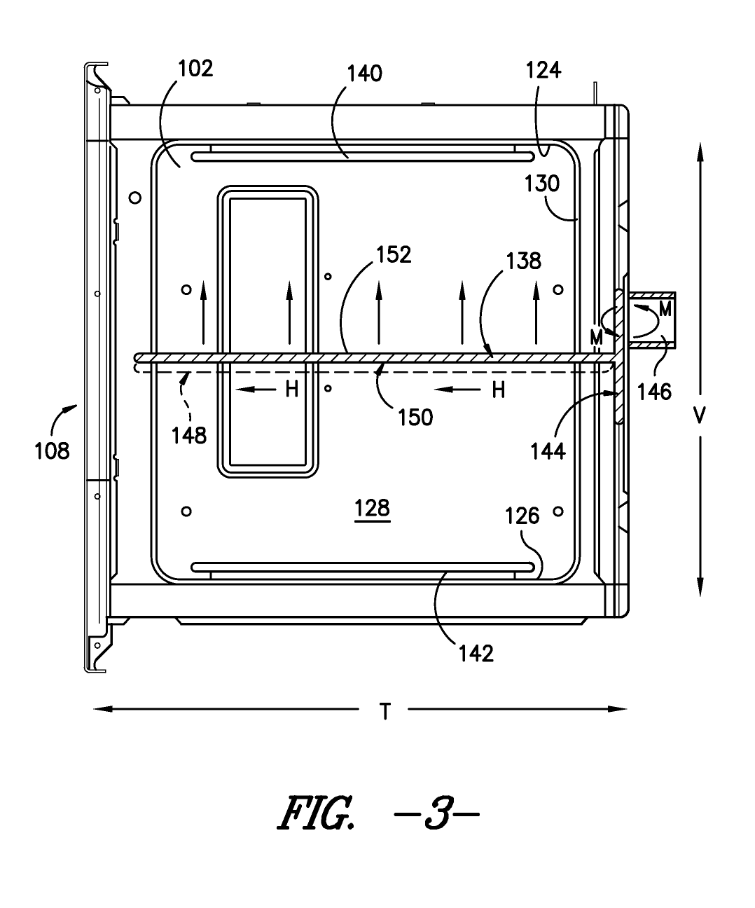

Oven 100 includes a user interface 116 having a display 118 positioned on a top panel 120 with a variety of controls 122. Interface 116 allows the user to select various options for the operation of oven 100 including e.g., temperature, time, and/or various cooking and cleaning cycles. Operation of oven appliance 100 can be regulated by a controller (not shown) that is operatively coupled i.e., in communication with, user interface panel 116, heating sources 140 and 142 (FIG. 3) that provide heat into the oven cavity 102, and other components of oven 100 as will be further described.

For example, in response to user manipulation of the user interface panel 116, the controller can operate heating element 140, 142, or both. For dual cavity operation, the controller can be equipped to operate heating sources 140 and 142 at different temperature settings. The controller can receive measurements from one or more temperature sensors (not shown) placed in oven chamber 102 and e.g., provide temperature indication(s) to the user with display 118. The controller can also be provided with other features as will be further described herein.

By way of example, the controller may include a memory and one or more processing devices such as microprocessors, CPUs or the like, such as general or special purpose microprocessors operable to execute programming instructions or micro-control code associated with operation of appliance 100. The memory may represent random access memory such as DRAM, or read only memory such as ROM or FLASH. In one embodiment, the processor executes programming instructions stored in memory. The memory may be a separate component from the processor or may be included onboard within the processor.

The controller may be positioned in a variety of locations throughout appliance 100. In the illustrated embodiment, the controller may be located under or next to the user interface 116 or otherwise within top panel 120. In such an embodiment, input/output (“I/O”) signals are routed between the controller and various operational components of appliance 100 such as heating sources 140 and 142, controls 122, display 118, sensor(s), alarms, and/or other components as may be provided. In one embodiment, the user interface panel 116 may represent a general purpose I/O (“GPIO”) device or functional block.

Although shown with touch type controls 122, it should be understood that controls 112 and the configuration of appliance 100 shown in FIG. 1 is provided by way of example only. More specifically, user interface panel 116 may include various input components, such as one or more of a variety of electrical, mechanical or electro-mechanical input devices including rotary dials, push buttons, and touch pads. The user interface 116 may include multiple other display components, such as a digital or analog display device designed to provide operational feedback to a user. The user interface 116 may be in communication with the controller via one or more signal lines or shared communication busses. Also, oven 100 is shown as a wall oven but the present invention could also be used with other appliances such as e.g., a stand-alone oven, an oven with a stove-top, and other configurations as well.

Referring now to FIG. 2, oven cavity 102 is defined in part by top wall 124, bottom wall 126, and side walls that include opposing walls 128 (only one of which is shown), and a rear wall 130. Heating sources 140 and 142 may be electrical resistant elements, gas burners, or other heat sources. Although shown within oven compartment 102, heating sources 140 and 142 may be located behind top wall 124 and bottom wall 126, respectively, as well.

Oven 100 includes a removable divider 132 that separates the oven chamber 102 into multiple portions—i.e. for this exemplary embodiment—an upper portion 134 and a lower portion 136. Divider 132 includes a shelf 138 that is connected to a vertically-oriented flux receiver 144. Shelf 138 extends from door 104 to rear wall 130 along the transverse direction T and extends between opposing walls 128 along the lateral direction L. As such, shelf 138 provides a location where a user may place one or more food items for cooking operations.

As shown in FIGS. 2 and 3, oven 100 includes at least one magnetic flux generating coil 146 that is positioned proximate to divider 132. More particularly, the flux generating coil 146 is positioned near the flux receiver 144 of divider 132. Coil 146 is also constructed e.g., from multiple wires such as e.g., litz wires. These wires are wound in a manner that creates a magnetic flux (arrows M in FIG. 2) to thereby generate eddy currents in the flux receiver 144 of divider 132 when energized by e.g., an alternating current of appropriate frequency.

In turn, because of its ferrous content, flux receiver 144 will create heat in response to the eddy currents. This heat will be conducted along shelf 138 (arrows H) and can be used for conductive and convective heating (arrows C) for cooking operations. The amount of heat generated can be controlled by e.g., the oven's controller through manipulation of the amount of power provided to coil 146.

By way of example, if a user of the appliance desires to cook two different food items at different temperatures, divider 132 can be placed into oven chamber 102 and e.g., attached to rear wall 130 to create upper portion 134 and lower portion 136. Through separate control of heating sources 140 and 142 and control of the amount of flux created by coil 146, the temperature of portions 134 and 136 can be separately controlled. In addition, whether located in upper portion 134 or lower portion 136, a food item placed in either portion will receive heating from both the top and bottom so as to provide for more uniform cooking and or browning.

In an alternative embodiment, divider 132 can be configured so that a user can cook with only the upper portion 134 or lower portion 136 when divider 132 is in place. For example, as shown in dotted lines in FIG. 3, divider 132 can be equipped with an insulating element 148 on a bottom surface 150 of divider 132. Food items can then be placed on top surface 152. Insulating element 148 helps to prevent heat from transferring into lower portion 136. Insulating element 148 can be removably attached to the bottom surface 150 of divider 132. In the alternative, element 148 could be removably located on top surface 152.

For certain exemplary embodiments, the position of divider 132 along the vertical direction V can be configured as adjustable. Using the teachings disclosed herein, one of ordinary skill in the art will understand that various mechanical features may be used to support divider 132 from e.g., rear wall 130, opposing walls 128, or combinations thereof. However, changing the position of divider 132 will also change the position of flux receiver 144. In order to provide sufficient magnetic flux lines across receiver 144, the size of coil 146 can be increased along vertical direction V.

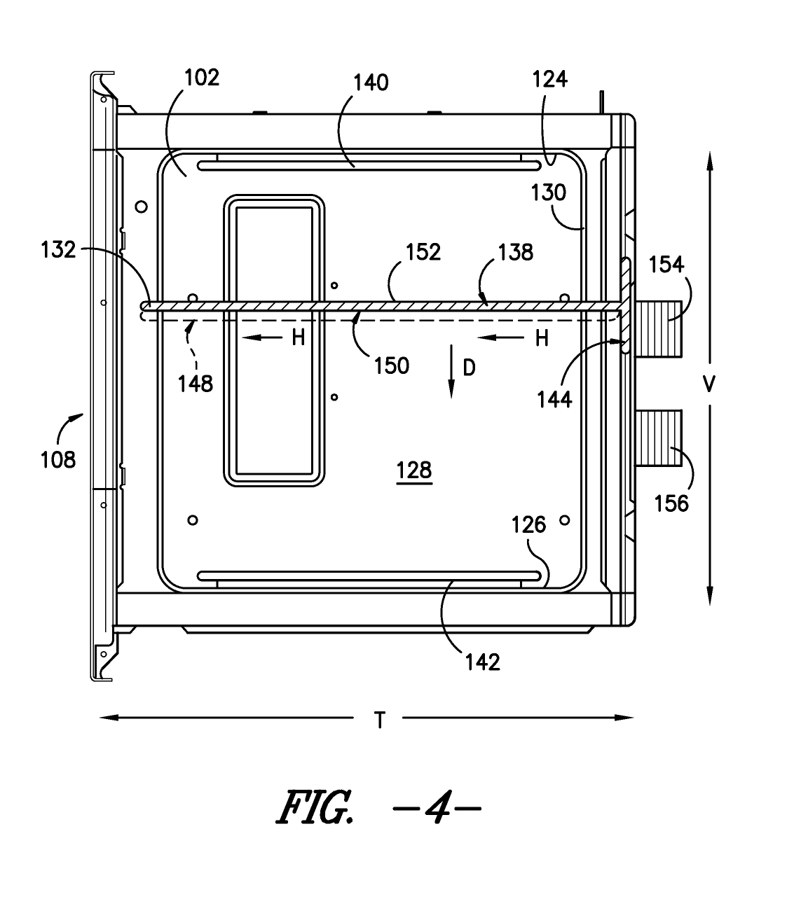

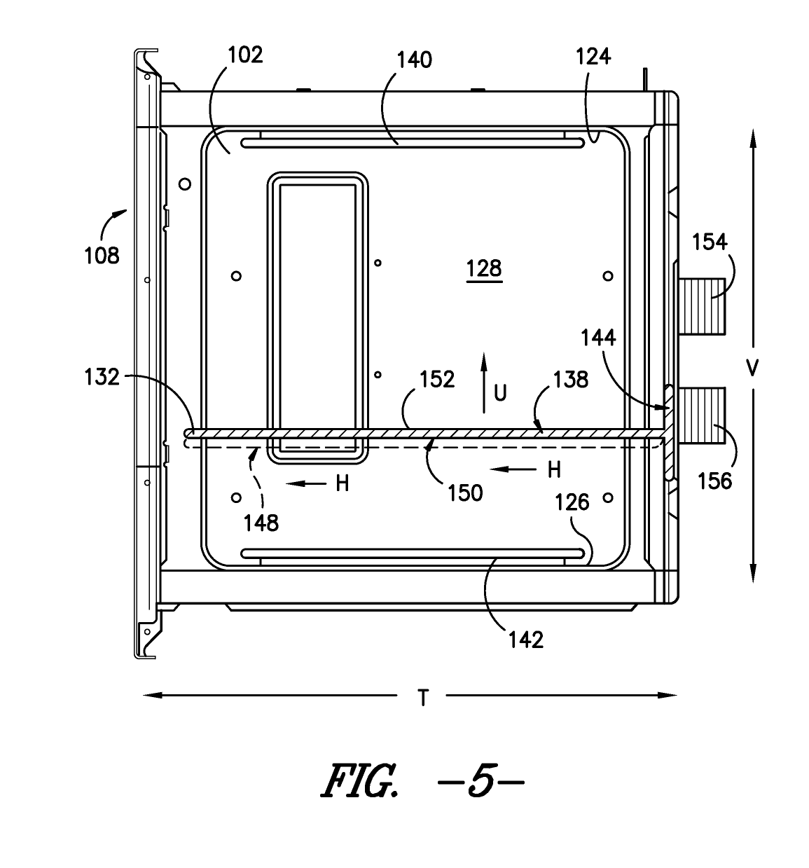

Alternatively, as shown in FIGS. 4 and 5, a plurality of magnetic flux generating coils 154 and 156 can be positioned on the rear wall 130. As such, when divider 132 is moved downwardly or upwardly (arrows D and U), sufficient magnetic flux will be provided across receiver 144 regardless of the position of divider 132. Other constructions may be used as well.

For the exemplary embodiments shown in FIGS. 2-5, rear wall 130 is shown positioned between divider 132 and flux generating coils 146, 154, and 156. This construction can provide certain advantages including a more pleasing aesthetic appearance for oven chamber 102 particularly since the operation of divider 132 does not require electrical connections that are visible from inside chamber 102. For this embodiment, rear wall 130 should be constructed from a non-ferrous material such as e.g., a ceramic material, an aluminum alloy, or combinations thereof. As an alternative, the magnetic flux generating coil may be positioned inside oven chamber 102 provided it is located proximate to the flux receiver 144.

Using the teachings disclosed herein, it will be understood that divider 132 can have different shapes and configurations from that shown in the figures, provided the construction is such that at least a portion of the divider will be positioned across the magnetic lines of flux created by the flux generating coil. In addition, divider 132 can be coated with one or more non-ferrous materials such as non-stick coatings. Examples of such include TEFLON® and ceramic materials, but others may be used as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance, comprising:
an oven chamber defined by a top wall, a bottom wall, and at least one exterior wall extending between the top wall and the bottom wall, the oven chamber defining an opening through which food items may be placed into the oven chamber for cooking operations;
a ferrous divider that comprises a shelf for the receipt of food items, said divider removably attached to the exterior wall and separating said oven chamber into multiple cavities; and
a magnetic flux generating coil positioned proximate to said divider so as to create eddy currents in the divider and generate heat when said coil is energized.

2. An oven appliance as in claim 1, wherein the position of said divider along the exterior wall is selectively adjustable.

3. An oven appliance as in claim 1, wherein the exterior wall is positioned between said divider and said coil.

4. An oven appliance as in claim 1, wherein said ferrous divider further comprises a flux receiver connected with the shelf and positioned for the receipt of magnetic flux from said coil.

5. An oven appliance as in claim 1, wherein the exterior wall defines a vertical direction extending between the top wall and bottom wall of the oven chamber, and wherein said coil further comprises a plurality of magnetic flux generating coils positioned on the exterior wall and spaced apart from each other along the vertical direction.

6. An oven appliance as in claim 1, wherein said divider further comprises a top surface and a bottom surface, and further comprising an insulator covering the bottom surface.

7. An oven appliance as in claim 1, wherein said exterior wall comprises a non-ferrous material.

8. An oven appliance as in claim 7, wherein said exterior wall comprises a ceramic, an aluminum alloy, or a combination thereof

9. An oven appliance as in claim 1, wherein said coil comprises litz wire.

10. An oven appliance as in claim 1, wherein said divider is coated with a non-ferrous material.

11. An oven appliance as in claim 10, wherein said divider is coated with a ceramic material.

12. An oven appliance, comprising:
a cooking chamber comprising a pair of opposing side walls, a rear wall, a top wall, and a bottom wall, said cooking chamber defining an opening for the receipt of food items for cooking;
a heating element for providing heat to said cooking chamber for cooking operations;
a divider comprising a shelf for supporting food items, said divider positioned in said cooking chamber so as to divide the cooking chamber into at least two portions, said divider comprising a ferrous material; and
a magnetic flux generating coil located near said divider and configured to generate eddy currents in the divider so as to provide heat for cooking operations.

13. An oven appliance as in claim 12, wherein said divider is supported by the rear wall.

14. An oven appliance as in claim 12, wherein said divider is supported by said rear wall and movable along a vertical direction between the top wall and the bottom wall.

15. An oven appliance as in claim 12, wherein said rear wall is positioned between said divider and said coil.

16. An oven appliance as in claim 12, wherein said divider further comprises a vertically-oriented flux receiver connected with the shelf, attached to the exterior wall, and positioned for the receipt of magnetic flux from said coil.

17. An oven appliance as in claim 12, wherein the exterior wall comprises a non-ferrous material.

18. An oven appliance as in claim 12, wherein the exterior wall comprises a ceramic, an aluminum alloy, or a combination thereof

19. An oven appliance as in claim 12, wherein said coil comprises litz wire.
